(19) United States
(12) Patent Application Publication
(10) Pub. No.: US 2020/0258495 A1
(43) Pub. Date: Aug. 13, 2020

(54) Digital audio methed for creating and sharingaudiobooks using a combination of virtual voices and recorded voices, customization based on characters, serilized content, voice emotions, and audio assembler module

(71) Applicant: Brett Duncan Arquette, Orlando, FL (US)

(72) Inventor: Brett Duncan Arquette, Orlando, FL (US)

(21) Appl. No.: 16/271,268

(22) Filed: Feb. 8, 2019

(51) Int. Cl. G10L 13/04; G10L 13/07; G10L 13/047

(52) U.S. Cl. CPC G10L 13/043; G10L 13/047; G10L 13/07

(57) ABSTRACT

Colabnarration is six-step process that allows authors to create their own audiobooks with or without human recorded narration. The processes described herein are;
1) Serialization of the text-based novel or book. This process creates a record for each paragraph of text in the book (text file) and also creates a proprietary file to be used within the software application.
2) Creation of a character file. This process allows the author to create a list of characters and add all pertinent information required in the recording process and/or the virtualization process.
3) Combining the serialized file with the character file creates the Snippet file, which is used in the Snippet Manager. In this process, the author can assign characters to every snippet (text block) which will be used in the following step.
4) Generate audio files using 3rd party text-to-speech APIs. Each snippet (text block) is sent to a virtual voice API and is converted into an audio file.
5) Once all the snippets have been converted to audio files this module concatenates all the files and creates the full audiobook.
6) Share the project with a narrator. This process allows an author to assign characters to a specific narrator who will record just those assigned characters. Once an author has shared the project with a narrator, the project is sent to the narrator via an automated email message.

### BACKGROUND

The current way that audiobooks are created is the author or publisher hires a human narrator to read and record the audiobook. The downside to this method is 1) cost of the narrator's time (per finished hour) of the recording 2) If the book is being read by a female and male narrator, then they both have to be in the same room at the same time to record the narration. 3) When two or more narrators are recording the book, they must perform this task in a serialized manner (line after line) which costs all parties in the process more money and time. 4) The author is limited to the number of voices and dialects the narrators can produce 5) The author has no input on how a line in their book should be read, which in this document is referred to as the emotion of the line. 6) A single version of the book is recorded and the manual process does not lend itself toward creating multiple versions of the audiobook, such as a classroom edition where a second version of a text block without profanity can be recorded as a school-friendly audiobook. 7) The collaborating element of this invention allows the author to hire several narrators and easily share the project via email, where each narrator can record their lines simultaneously from anywhere in the world. For example, an author might have some lines in their book that are written in Spanish. Using the collaborating tools within this invention, this language can be farmed out to a Spanish-speaking narrator. Child-spoken sections of the novel can be farmed out to children narrators (yes, believe it or not, there are children narrators). 8) If an author receives the audio package back from a real narrator and doesn't like the way a particular line was read, the author can request that just that one line be reread and sent to them, eliminating the complex process of the narrator having to use editing software to complete this task.

This method of creating an audiobook is not merely hypothetical. The inventor of the CoLabNarration method has written a production-ready software application. This software walks the author through the process with helpful wizards and intuitive design. The inventor of the CoLabNarration process has used this software to create the first combined text-to-speech and real narrator finished audiobook, in which a sample can be heard at this link: http://www.arquette.us/CoLabNarration_example.html

Once the CoLabNarration process has been adopted by authors and publishers, it will allow any author to create their own audiobook for a fraction or the cost. For example, the last audiobook the inventor of the CoLabNarration process wrote cost him $4000 (US) to be read by a human narrator. Contrarily, if the entire book was created by text-to-speech virtual voices, the current cost of using a popular API would cost a total of $2 dollars. Creating a second version would cost an additional 5 cents.

### SUMMARY

The popularity and sales of audiobooks has been growing at 16% per year, since many of the younger generation prefers to listen rather than read. This market has been a closed door to authors who cannot afford to hire a narrator to record their books. The CoLabNarration method will allow independent authors to have their work converted to an audiobook for a fraction or the cost and time, and will provide them much more creative control. As time and technology marches forward, text-to-speech voices will become refined to a point where they are indistinguishable from real human voices. At this point, all subsequent audiobooks will be created using the CoLabNarration method. There simply won't be reason to use real narrators, thus eliminating the historical costly method of turning books into audiobooks.

### BRIEF DESCRIPTION OF THE DRAWINGS

This detailed description is provided with relevance to the accompanying figures. In the figures, the leftmost digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a screen shot of the process that converts the text-based book to a file that can be read by the CoLabNarration software.

FIG. 2 is a screen shot of the Character Manager in the CoLabNarration software. This figure illustrates the user interface (UI) used to create Characters for the project by adding data elements that are critical to the human recording or text-to-speech process.

FIG. 3 is an screen shot of the Snippet Manager in the CoLabNarration software, where the word Snippet refers to a block of text that has been serialized and displayed on the screen. This figure illustrates the user interface (UI) for modifying project snippets, as well as adding data elements that are essential to the recording or text-to-speech process.

FIG. 4 is again an actual screen shot of the Snippet Manager in the CoLabNarration software, but this view shows the remainder of the fields not included in the previous figure. In this figure, the horizontal scroll bar has been moved all the way to the left, exposing more fields on the right

FIG. 5 is a screen shot of the text-to-speech Manager in the CoLabNarration software. This figure illustrates the user interface (UI) process for sending text to an API engine and receiving audio files in return.

FIG. 6 is an actual screen shot that represents the process of concatenating all the audio files into a contiguous audiobook. This figure illustrates the user interface (UI) process that assembles (potentially) thousands of audio files into a coherent audiobook that is ready for sale.

FIG. 7 is a flow diagram depicting a step-by-step process of creating an audiobook using the CoLabNarration method/process.

FIG. 8 is a flow diagram depicting the collaboration process of creating an audiobook using the CoLabNarration method/process.

FIG. 9 is a flow diagram depicting the process of concatenating all the audio files into a complete audiobook using the CoLabNarration method/process.

FIG. 10 is a flow diagram depicting the serialization process used to convert a text-based book into a serialize file used by the CoLabNarration method/process.

FIG. 11 is a screen shot depicting the first of two recording modes that is presented to the human narrator via the UI.

FIG. 12 is a screenshot depicting the second of two recording modes that is presented to the human narrator via the UI.

FIG. 13 This figure illustrates the user interface (UI) process that allows the user to listen to audio that has already been recorded or virtualized used by the CoLabNarration method/process.

FIG. 14 This figure illustrates the user interface (UI) process that allows the author to securely share a project with multiple narrators.

FIG. 15 This figure illustrates the email sharing process and illustrates the method in which a narrator would receive and import a CoLabNarration project.

### COLABNARRATION DESCRIPTION

Today, there is only one method of creating an audiobook. Each word has to be read by a real human narrator, while being recorded, and then edited to create an audiobook.

The Big Five traditional publishers now account for only 16% of the e-books on Amazon's bestseller lists. Accordingly, self-published books now represent 31% of e-book sales on Amazon's Kindle Store. Independent authors are earning nearly 40% of the e-book dollars going to authors.

Self-published authors are dominating traditionally published authors in sci-fi/fantasy, mystery/thriller, and romance genres. Independent authors are taking significant market share in all genres, yet very few authors can afford to have their work made into an audiobook. The CoLabNarration method makes it possible for even the poorest of authors to turn their book into an audiobook. This disclosure describes systems and techniques for an author to instigate a process whereas their text book can be made into an audiobook.

The heart of the CoLabNarration process consists of six unique steps. This six-step process or method allows authors to create their own audiobooks with or without humanly recorded narration. The six techniques described herein are:

1) Serialization of the text-based novel or book. This process creates a record for each text paragraph in the book (file) and also creates a proprietary file to be used within the CoLabNarration software application.
2) Creation of a character file. The process allows the author to create a list of characters and add all pertinent information required by the recording process and/or the virtualization process.
3) Combining the serialized file with the character file creates the Snippet file, which is used by the Snippet Manager in the CoLabNarration software. In this module, the author can assign characters to every snippet (text block) which will be used in the following step.
4) Generate audio files using 3rd party text-to-speech APIs. Each snippet (text block) is sent to a virtual voice API and converted to an audio file.
5) If the author would like snippets recorded by a human narrator, then the author could use the CoLabNarration sharing method to allow multiple narrators to work on the project.
6) Once all the snippets have been converted into audio files and/or all the audio files have been received from the assigned narrator, this final module concatenates all the files, inserts appropriate time delays, and creates the audiobook.

To date, there is no definitive roadmap for authors to create an audiobook using text-to-speech technology, and there are several reasons for this. Authors tend to be left-brain people, who are great at creating wonderful stories and have the fortitude to sit down and turn their ideas into books. The right-brain folks happen to be the technically inclined people who can write code, yet do not have a clue how authors function. You almost have to be an author in order to design the text-to-speech audiobook process for an author. Since the inventor of the CoLabNarration process is both an author, as well as a software coder, he was able to cross the great divide and construct a process realized in his CoLabNarration software. As such, CoLabNarration is an unique audiobook invention created by an author.

The user interface responsible for converting the text-based book into a CoLabNarration file is referred to as the serialization process. The only interaction the author has with this fully automated process, is the selection of their text file to be converted. Once the author has selected the correct file, this module performs a series of complex algorithms which breaks the text file up into individual records that are stored in the snippet file structure. At the end of this process a snippet file has been created. The snippet file is read into the software and automatically opened in the Snippet Manager data grid. Once the Snippet file has been created, the next step for the author is to create the Character file. Inside the Character Manager, the author creates a new character based on each character in their novel. The author is required to fill in some data fields in the character manager that are critical to the virtualizing and sharing components in later processes. The author can also fill in data elements that may be necessary for a human narrator to record the character. For example, the free form text column VOICE TONE in the Character Manager data grid provides the narrator information such as “New York Accent” or “SHY” or even descriptive phrases such as “RUGGED” or “DEEP”. While working inside the Character Manager, the author can assign a character an age, sex, a physical description and a personality description. Since many characters in novels are referred to by a nickname, the author can add up to two nicknames per character, which, for example, might consist of a street name or a colloquialism. In addition, the author can select a background and foreground color for the character, which is also used in the Snippet Manager. This color coding of snippets provides the narrator recording the audio the ability to see visual cues of characters they will be recording. The additional fields in the Character table are data elements that are used in the text-to-speech process. The two fields used in the process are Sound Name and Sound Mods. These fields are selected by the author from the dropdown list and mirror names use by specific text-to-speech API services from such companies as Google and Amazon. For example, the name “Brian” on the Amazon Polly API assigns this snippet of text to one of Amazon's text-to-speech characters called “Brian” who speaks with an English accent and speaks in a midlevel tone. The Sound Mods field consists of flags that tells the text-to-speech API to return files that are read faster (speed) or higher (tone) or louder (volume). These flags set the tone, speed, and volume for each character, but can be overridden by the Emotions field in the Snippet Manager. The last field in the Character file allows the author to lock a character, which prevents a second narrator from accidentally recording over a previous recorded snippet. By locking the character, neither the text-to-speech process or human narrator can overwrite previously created audio files.

The function of the Snippet Manager module allows the user to interact with each block of text (snippet). This interface enables the author to edit text, view character information, create different versions of audio, define which text blocks are assigned to a specific character, assign a Snip Type to each block, such as Book Title, Publishing Information, Dedication, Chapter, Chapter Break, Dialogue, Narration, and Book End parameters. Within the Snippet Manager, the author or narrator is presented with information or visual cues which indicate if the snippet has previously been recorded by either a human narrator or text-to-speech. The Estimated Duration column in the data grid is represented by the number of estimated seconds each text block will take to read. The estimated duration of each block of text (snippet) is calculated in order to provide the author comprehensive project statistics. For clips that have been recorded or created by text-to-speech, the Actual Duration column in the data grid represents the true value (in seconds) of the recorded audio file. The Estimate Duration and Actual Duration work in concert, especially when it comes time for an author to select a human narrator. The Estimated Duration provides the author with the estimated time it would take to record each character, all male snippets, all female snippets, as well as and Total Project Duration. An author requires this information in order to estimate how much they will pay a human narrator, prior to choosing a narrator for the assigned snippets. For example, the project's total male minutes might equal two hours, minus the narration text blocks. The author could then approach a human narrator and offer the narrator the job of recording all the male character snippets in the project, with the understanding they will be paid for approximately two finished hours of work. Once the human narrator has recorded all the snippets for each character assigned to him, the Actual Duration would constitute the payable hours from the author to the narrator, which may defer slightly from the estimate duration. Other informational fields in the Snippet Manager provides information to a human narrator, indicating that the text block is in English, denoted in the Language column of the data-grid. The final field in the Snippet Manager is referred to as the Snippet Number or Snippet ID. This number is used for data grid navigation, as well as a reference to concatenate audio files in the correct order. During the creation of the snippet file, the text block Snippet IDs are spaced in ten numbered increments in order to allow the author to add up to nine new snippets between each Snippet ID.

The Text to Speech Generator module allows the author to designate range of Snippet IDs will be recorded using text-to-speech. As an option to using a range designator, the author can also identify specific characters to be rendered via text-to-speech, or all male and/or female characters. The interaction with the text-to-speech API can be visualized on the screen by checking the box Delay, which will show each block of text on the screen during the virtualization process. This visual reference provides the author visual feedback of what is taking place. If the Delay box is unchecked, then all of the calls to the text-to-speech API are done behind the scenes which allow the virtualization to run 100-times faster. By benchmarking the text-to-speech turnaround, real world tests indicate the time it takes to convert all the Snippets to audio, for an entire book, can be done in less than two minutes, using the modern text-to-speech APIs. The same length book read by a human narrator could take up to four months to complete.

Prior to the CoLabNarration application and its Project Statistics module, an author who wanted to hire a narrator had no idea how much audio (reflected in seconds) would be read by the human narrator. Therefore, the author had no idea how much the project would cost. The Project Statistics screen calculates the Estimate Duration of all the snippets in the project and breaks it down in total seconds for each character, all male characters, all female characters, as well as isolating the number of seconds to record the narration segments. The module then calculates the duration of the entire project showing Total Project Seconds, Total Project Minutes and Total Project Hours. These statistics enable an author to offer narrators individual characters to record, since the author knows how many estimate seconds each character takes to record.

In the Make Audiobook module, during the execution of this code most of the heavy lifting is done behind the scenes. Prior to the author clicking the Start button, the author can select which version of the audio book they wish to assemble. By checking the box labeled Mixed Recorded and Virtual Voices it tells the program to use human recorded audio files in lieu of text-to-speech audio. If both human recorded and text-to-speech files exist, the text-to-speech files are ignored. Prior to concatenating the audio files, each file is run though a filter that eliminates silent segments in the beginning and end of each audio file. Once this trimming pass has completed, the concatenation process takes place. During this process, the Snippet Type is analyzed and a appropriate duration of silence is inserted between the files. For example, after a Chapter Title is identified, a full one second segment of silence is insert between the Chapter Title and the next Snippet. In concert with this logic, the last character of each block of text is extracted and analyzed, which again, allows the program the ability to assess the amount of silence that should be inserted between snippets. For example, if a ‘comma’ is the last character of the text block and the text block type is ‘Dialogue’ then a very short 0.25 second of silent audio is inserted to separate the audio snippets. If a ‘period’ is the last character of the text block, then a 0.75 second of silence is inserted between then audio snippets. This intuitive spacing of audio snippets ensures that the concatenated audio flows naturally and has the proper cadence.

In the description below, techniques for creating an audiobook in the context of creating text-to-speech and human recorded audio are defined:

### Term Examples

“CoLabNarration and CoLabNarration process” refers to the six methods and techniques described within this invention.

“Project” refers to each individual book that is ingested into the CoLabNarration application.

“Project Statistics” describes character seconds, male seconds, female seconds, narration seconds, and total project seconds.

“Text to Speech Generator” describes the module responsible for performing the text-to-speech (virtualization) operations.

“Actual Total Project Duration” describes the total number of seconds, minutes, and hours of a project.

“Estimate Total Project Duration” describes the estimate total number of seconds, minutes, and hours of a project.

“text block” refers to individual blocks of text that form snippets.

“data-grid” describes the way data is presented in both the Snippet, Narrator, and Character Manager UI.

“module” describes a UI that allows the author to perform various functions.

“Snippet or Snip” describes a serialized block of text contained within the Snippet file structure.

“Snippet Manager” refers to the software module UI that manages Snippets.

“Snippet File” refers to the backend data structure and specifically denotes the file used in the Snippet Manager.

“Snippet number or ID” refers sequential number structure, whereas each Snippet is assigned to a numerical ID.

“Audio Snippet” describes a block of audio assigned to the Snippet that has been recorded or created using text-to-speech. (also referred to as “Snip”)

“Virtualization process” describes the process or method for creating virtualized (text-to-speech) audio files.

“Recording process” describes the process or method for creating human recorded audio files.

“Emotion of the line” refers to a field within the Snippet Manager file structure and denotes the emotion of the line using descriptive words and phrases.

“Character Manager” refers to a UI module that allows authors to control Character content.

“Character file” refers to the backend data structure and specifically denotes the file used in the Character Manager.

“Narrator Manager” refers to a UI module that allows authors to share the project with multiple narrators.

“Narrator file” refers to the backend data structure and specifically denotes the file used in the Narrator Manager.

“Sound Name and Sound Mods fields” refers to separate fields located within the Character file.

“Emotion field” refers to the backend data structure and describes the emotion of each snippet.

“Snip Type field” refers to the backend data structure and describes the type of snippet.

“Language field” refers to the backend data structure and describes the language used in a snippet.

“Narrator” refers to the backend data structure and describes any snippet designated as Narration.

“active data-grid control” (ADGC) describes the ability to click on a cell in the data-grid and execute an action or event.

“application program interface” (API) is a set of routines, protocols, and tools for building software applications. In this submission, all mentions of the API refer to text-to-speech services.

SSML is an acronym, which represents Speech Synthesis Markup Language, an XML-based markup language for speech synthesis applications.

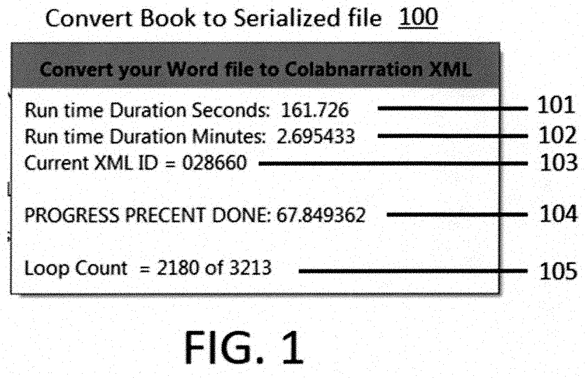

FIG. 1 Convert Book to Serialized File—is an illustration of the process that creates a file that can be read by the CoLabNarration software 100. The fields that are displayed while this process is running 101 and 102 provides the time (in seconds) it took to create the file. The current XML ID 103 displays the current snippet ID that is being processed. The progress percent 104 displays how much of the conversion has taken place. The Loop Count 105 equates to the number of snippets in the project.

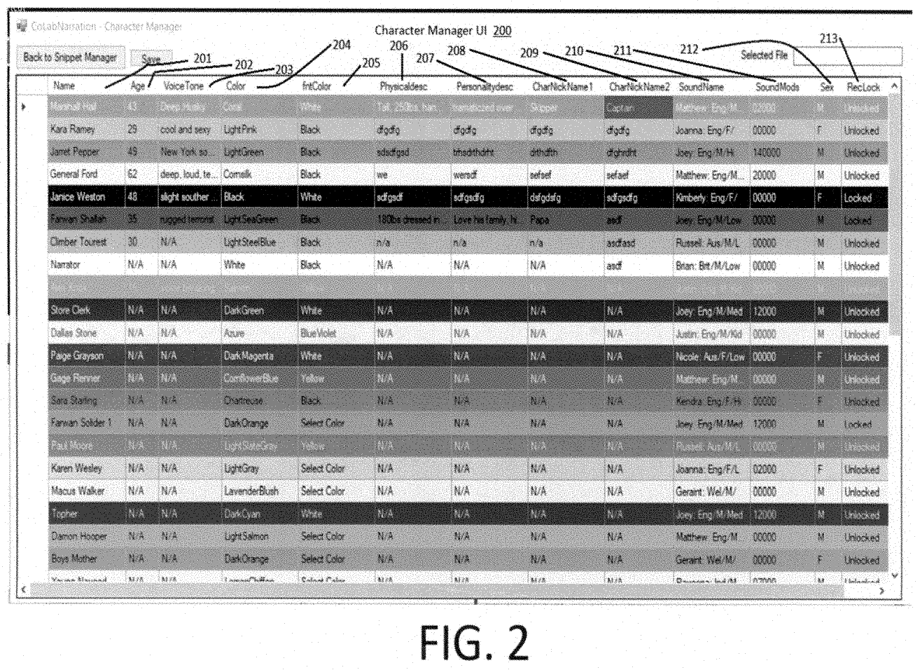

FIG. 2 Character Manager UI—in the CoLabNarration process this module allows an author to identify characters from their book and reflect those characters in the project 200. The Name field 201 is an active data-grid control (ADGC) that allows the author to choose the character they wish to associate with a snippet from a dropdown list. The Age field 202 is a control that assigns the character's age. The voice tone field 203 is a free-form text field that allows that author to describe the tone of the character. The color field 204 is an ADGC that allows the author to choose a line color from a dropdown list. The fntColor field 205 is similar to the color field, but this ADGC changes the font color of the character. The Physicaldesc field 206 is a free form text field that allows the author to describe the physical characteristics of a character. Similar to this field, the Personality field allows the author to describe a character's personality. Both the CharNickName1 208 and the CharNickName2 209 are free form text fields that allows the author to provide multiple nicknames for each character. The SoundName field 210 allows the author to select a text-to-speech name a list of virtual voices in a dropdown list. Each virtual voice corresponds to the voice name used in the text-to-speech API. The SoundMods field 211 is a collection of parameters that are assigned to a character, based on which SoundName the author selects. These settings control the speed, the tone, and the volume of the character during the virtualization process. These audio characteristics are reflected in the audio file that is returned from the text-to-speech API. The sex field 212 allows the author to denote the sex of the character. The Reclock field 213 is a binary control that locks and unlocks a specific character, protecting preexisting audio files from being recorded over. This is a preventive measure that is necessary when the project is shared between multiple human narrators.

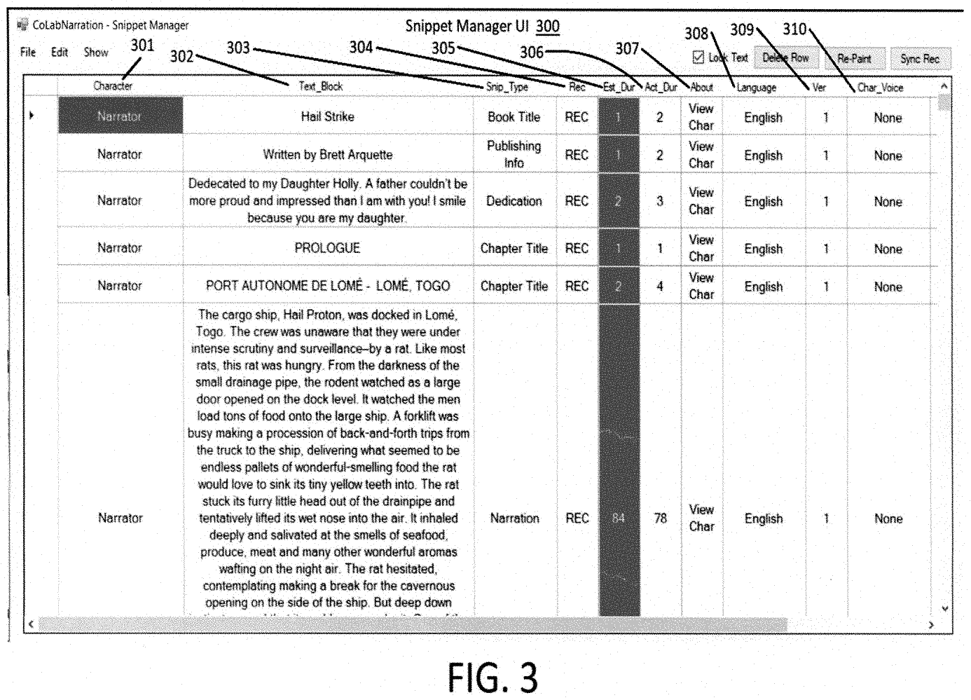

FIG. 3 Snippet Manager UI—is an illustration of the data elements returned from the converted book to a serialized project file 300. The Character field 301 is an ADGC that allows the author to assign a snippet of audio to a specific character via a drop down list. Once the character has been assigned, the character's color and font color are reflected in the snippet row. The Text Block field 302 is a free form text field that contains the text blocks from the author's original text file. This field can be locked or unlocked, which allows the author to change text and then lock it once they are done making modifications. The Snip Type is an ADGC the author uses to assign the snippet a specific type. From a dropdown list the author can choose Book Title, Publishing Info, Dedication, Chapter Title, Chapter Break, Narration, Dialogue, and Book End. Each of these items are considered when adding silence between audio segments during the concatenation process. The REC field 304 is a dual-purpose display that shows the text “REC” when a human narrator has recorded the snippet. The field also turns red in order to provide a visual cue that the snippet has been recorded. The Est_Dur field 305 is seeded with the estimated duration of each snippet, which is calculated during the convert a book to a serialized file process. The color of this field turns red when a text-to-speech audio file has been created via the virtualization process. This color change provides a visual reference as to which files have been created by the virtualization process. The About field 307 is an ADGC that displays a popup box that contains all the fields for that character from the character file. This provides an author or narrator a fast way to view a specific character's information without leaving the Snippet Manager screen.

The Language field 308 is a free-form text field that allows the author to denote what Language is being used in the text block for that snippet. The Ver field 309 displays the current version of this snippet. The author can create multiple versions of snippets, thereby allowing each concatenation process to build a specific version of the audiobook. For example, there may be snippet with the text, “That's complete bullshit,” but the author could copy that snippet, adding a second version of the text block that reads, “That's complete horse-hockey.” Versioning also comes into play if an author hires two narrators who are reading the same parts. One human narrator can read all the parts in version one and the second human narrator can read the same snippets as a second version. At this point, the author can decide which narrator did a better job and create the audiobook with the appropriate version. The Character voice field 310 is an ADGC that allows the author to select a text-to-voice character and apply that voice to the snippet. This field is critical and allows the snippets to be virtualized.

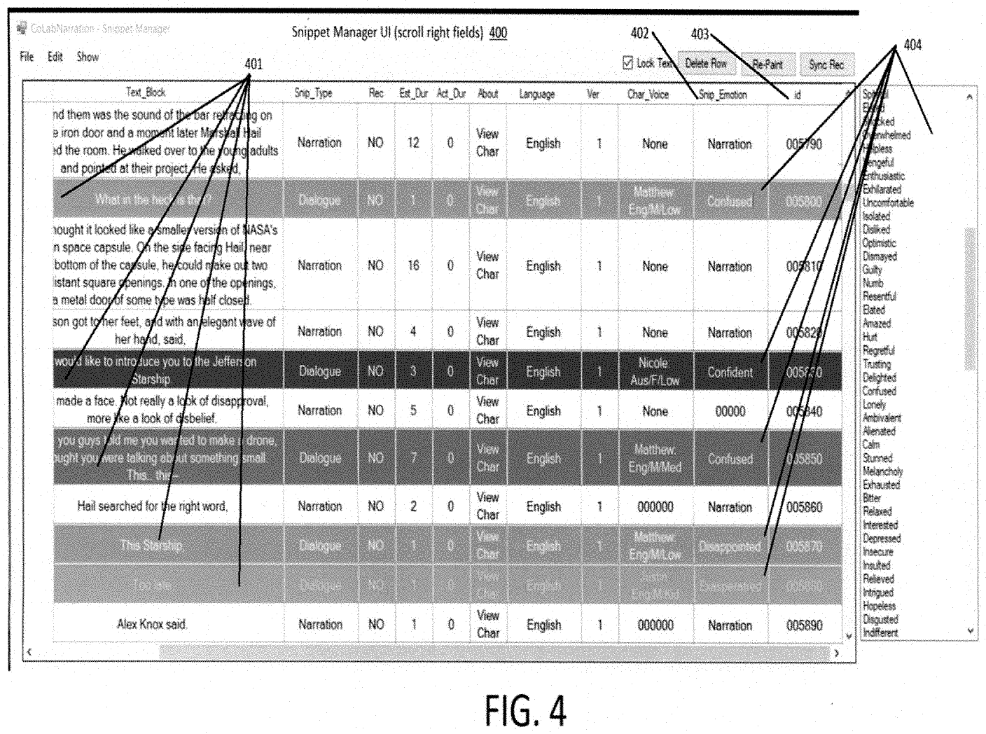

FIG. 4 Snippet Manager UI—(scroll right fields) is an illustration of the data elements on the right side of the data-grid, returned from the convert book to a serialized project file project 400. Visual references that denotes what character belongs to each snippet is reflected in the row and font color 401. While using a human narrator to record snippets, it is important for the narrator to see which character is coming up and the colors are a great visual cue. If a character's colors are changed in the character file, those changes repaint the Snippet Manager data-grid rows with the updated colors. The Snip Emotion field 402 is selected by the author and is a dual-purpose field. It provides a human narrator the emotion the author is conveying and also is used during the virtualization process using specific parameters that interact with the text-to-speech API. These parameters consist of tone modifications, speed modifications, volume modifications, and also uses SSML keywords which emphasize words and phrases when the snippets are being virtualized. This combination of text-to-speech parameters works to create emotion within the snippet that is selected. In the dropdown list 404, the author is offered more than a hundred emotions that can be assigned to a snippet.

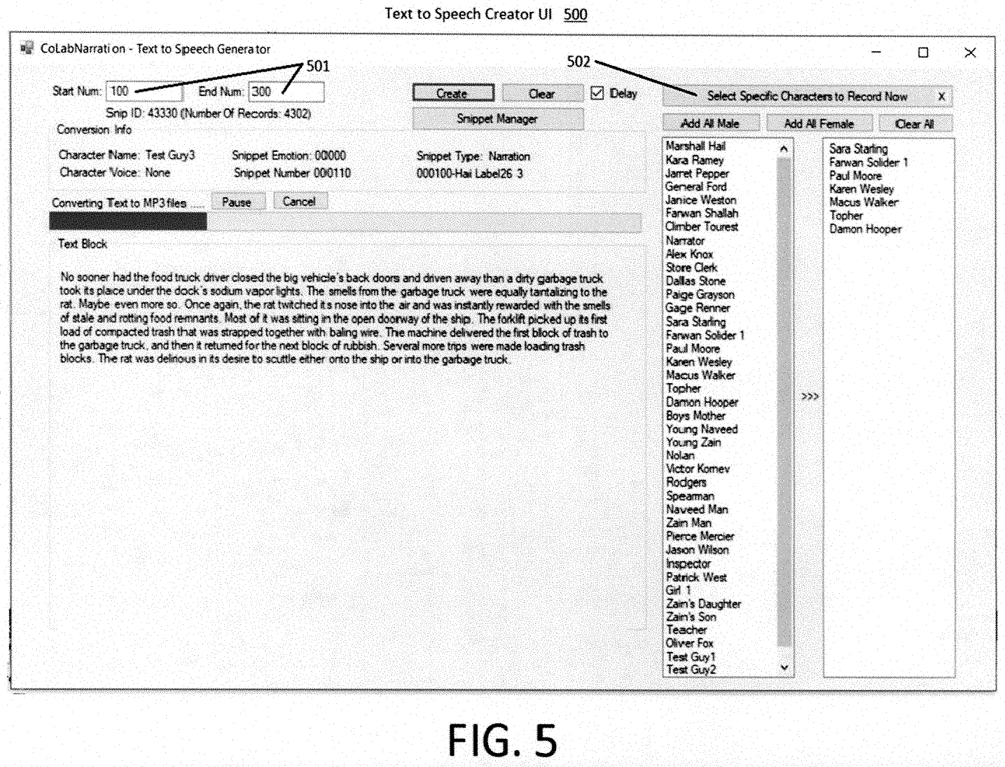

FIG. 5 Text to Speech Generator UI—is an illustration of the methods and selections presented to the author in order to virtualize snippets 500. This module allows the author to select a span of snippet IDs that will be virtualized 501 as well as selecting specific characters and/or combination of characters to be virtualized. Using the character selector 502 the author also has the option of selecting all male characters, all female characters, or a combination of both or individual characters. The data elements that are displayed on this screen change as each snippet is virtualized. From the user's perspective, the UI of the module is simple, however the backend coding and collection parameters from the Snippet and Character files and then passing that data to the text-to-speech API, is very complicated. Making this process even more complicated is the fact that each text-to-speech vendor requires different formats and API keys in order to virtualize snippets. All of these complex tasks are performed behind the scenes and not exposed to the author.

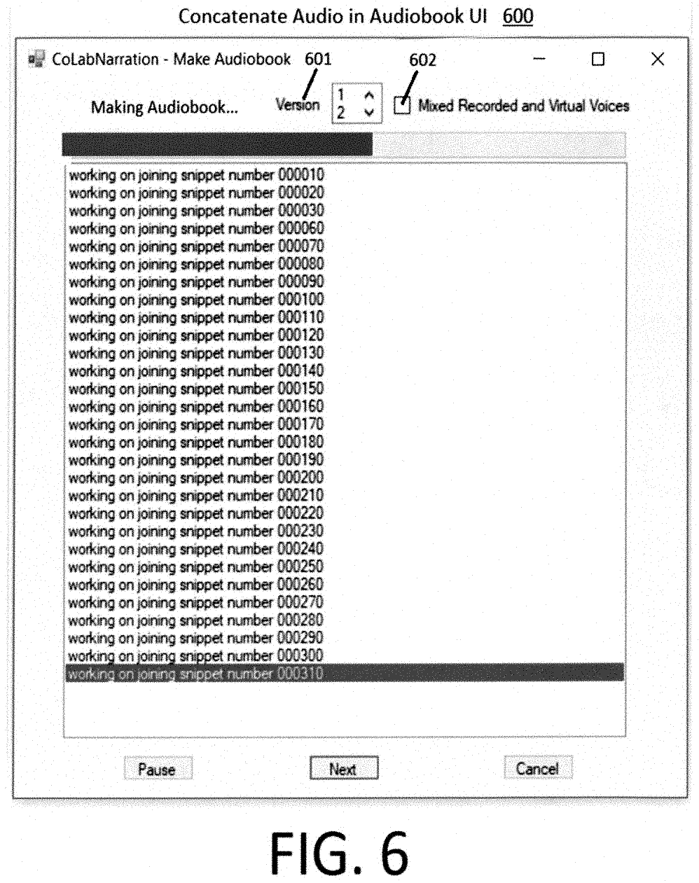

FIG. 6 Concatenate Audio UI—is an illustration of the method used to create the finished audiobook 600. The author is walked through two steps in order to run this module. The version selection 601 allow the author to select the version of audio they wish to make. If, for example, Version 2 is selected, then every time the process runs into a duplicate snippet number, the second audio file is used instead of the first audio file. Each time the author duplicates a snippet record; the version number is incremented and is displayed in the dropdown box in the UI. The only other choice the author must make is to check or uncheck the “Mixed Recorded and Virtual Voices” 602. If this box is checked then the process uses both human recorded narration, as well as text-to-speech audio. If both a human narrated and virtual audio file exist, then the human narrated audio file is used and the virtual audio file is omitted in the build. Prior to concatenating the audio files, a continuity scan is run that verifies that each snippet has an audio file associated with it. If not, an error message is generate and the author will need to record the orphaned snippets in order to build the audiobook.

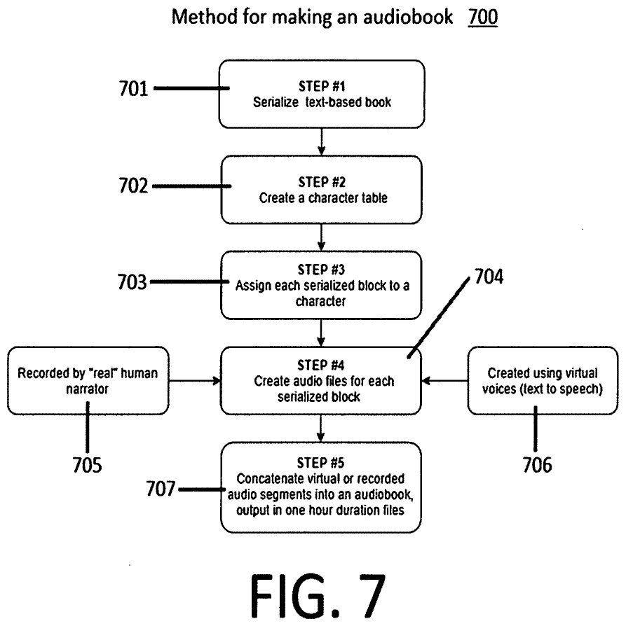

FIG. 7 Method for Making an Audiobook—is a diagram depicting the five-step CoLabNarration process 700. STEP #1 701 is the serialization of the text book. Along with this method, proprietary algorithms automatically assign snippets to the appropriate character, as well as assign Snip Types to each snippet. For each character assigned to a snippet a default record of that character is created in the character table. The end result of this process is a data file that can be read by the CoLabNarration application. STEP #2 702 represents that creation of a character dataset or file. Using a manual process, the user can use the Character Table Manager to modify, add or delete characters from the project. Within the module, colors can be assigned to represent characters, virtualize voices are assigned to characters, as well of personal information about each character. STEP #3 703 represents work that is performed in the Snippet Manager. Within this module, the author can assign snippets to characters, correct snippets that are assigned to the wrong character (from STEP #1), as well as assign the appropriate Snip Type to each snippet. The interface also allows the human narrator a recording interface (recording mode #2) as well as the ability to assign emotions to each snippet. Once all the additions and modifications have been made in the Snippet Manager, then the next step can continue. STEP #4 704 is the module that performs the text-to-speech operations with a 3^{rd} party API. Within this module, the author can incorporate virtualized voices into the project by running the Text to Speech interface. When this process is run it sends a SSML text stream to the API engine, which returns a virtualized audio file. This process also itemizes each audio file transaction and associates the audio file with the snippet file by giving the audio file the same snippet prefix number. These audio files may consist of audio recorded by a human narrator 705, or virtualized audio files 706, or a combination of both. STEP #5 707 represents the module that concatenates all the audio files into a complete audiobook. Within this module, several audio file processing tasks take place. The first action preformed removes all silent segments in the front and the back of the file. This sets both the lead beginning/end silence of human recorded audio files and the lead beginning/end silence of virtualize audio files. This task creates a baseline for all audio files and is vital to the next task. The second significant action the module performs is to analyze the previous, current, and next text snippets and determines the amount of silence to be added to each snippet. The last task of the concatenation module is to break each audiobook file at the one-hour mark, which is typically the format that publishers desire.

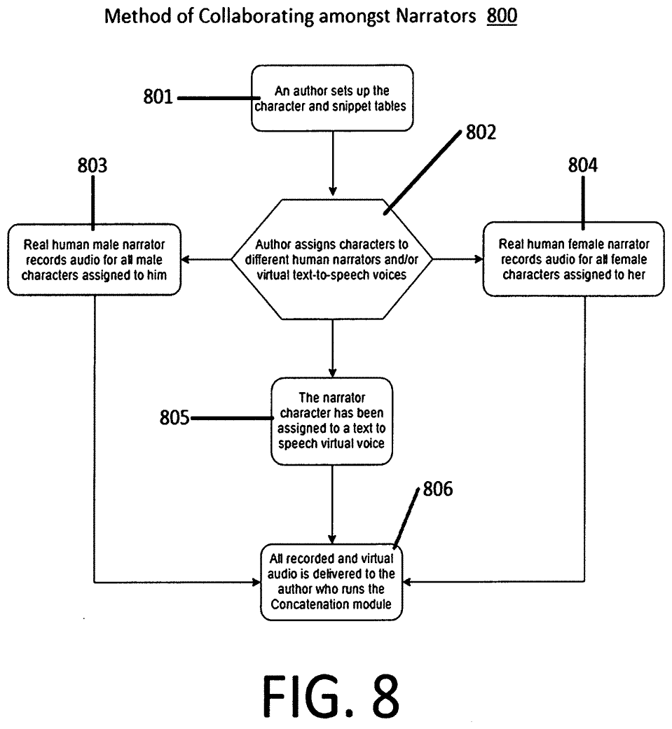

FIG. 8 Method of Collaborating Amongst Narrators—is a diagram that depicts the method in which an author may collaborate with multiple human narrators within a single CoLabNarration project 800. Once the author has finalized modification on both the character and snippet files 801 then the author can use the Project Sharing module which assigns specific snippets to specific human narrators 802. Once the narrator has received the project, he/she can record all the characters that are assigned to them 803 and 804. This illustration shows that the narration Snip Typed will be created via text-to-speech 805. The final step in the sharing process involves the narrators exporting the project and the author importing the content back into the project 806.

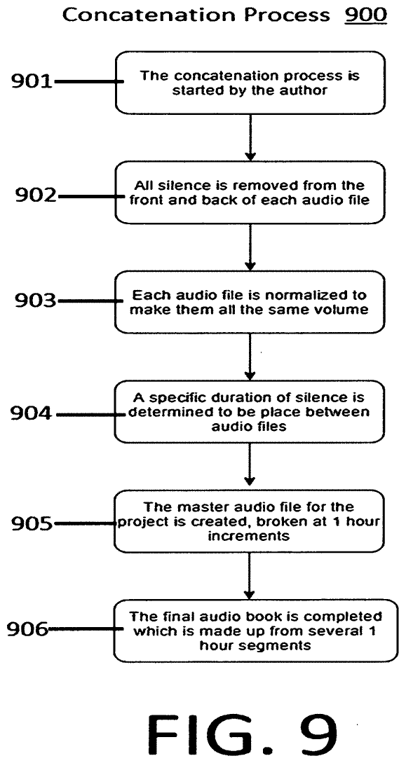

FIG. 9 Concatenation Process—is a diagram that depicts the method in which the thousands of audio snippets are assembled into contiguous 1-hour segments 900. Using the Make an Audiobook module, the author begins the creation process 901. The first task the process addresses is the amount of silence at the beginning and end of each audio snippet. This task is essential in equalizing the lead and end of each snippet so that a predetermine amount of silence can be inserted between snippets 902. The next task is to normalize each of the audio files, which increases or decreases the volume of each snippet, to create a baseline signal amplitude. This type of edit in the audio industry can also be referred to as “compressing” the audio 903. The next task in the process analyzes the snip type and then assigns an appropriate amount of silence between snippets. For example, a longer portion of silence will be inserted between the BOOK TITLE and the AUTHORS NAME than would be inserted at the end of standard paragraph 904. The next task in the process is to continually add the duration of each snippet added to the file until the concatenated file is approximately 1-hour in duration. At each hour of duration a new file will be created and the concatenation process will continue until all snippets have been concatenated into 1-hour audio files. When the process is completed, the author will have a completed audiobook broken down into several 1-hour segments 906. At this point, the audiobook can be submitted to a publisher for their consideration.

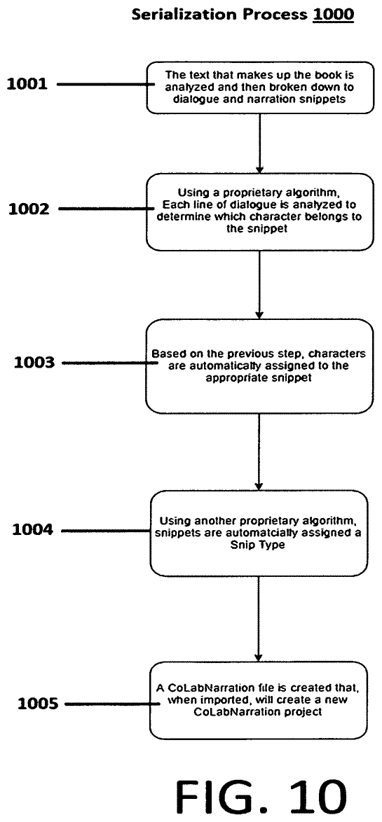

FIG. 10 Serialization Process—is a diagram that depicts the CoLabNarration serialization process of the authors text book into a serialized file that can be used in the CoLabNarration process 1000. The first step in the process is to analyze the text book file and to break it down into ordered text blocks that are either dialogue or narration 1001. In the next step a proprietary algorithm is used to determine which snippet belongs to which character 1002. Any snippet that can't be paired with the character is left for the author to manually assign 1003. Using another proprietary algorithm, each snippet is also assigned a Snip Type. The Snip Type defines what type snippet is represented and is also used in the concatenation process 1005. Possible Snip Typed values include: Book Title, Publishing Information, Dedication, Chapter, Chapter Break, Dialogue, Narration, and Book End.

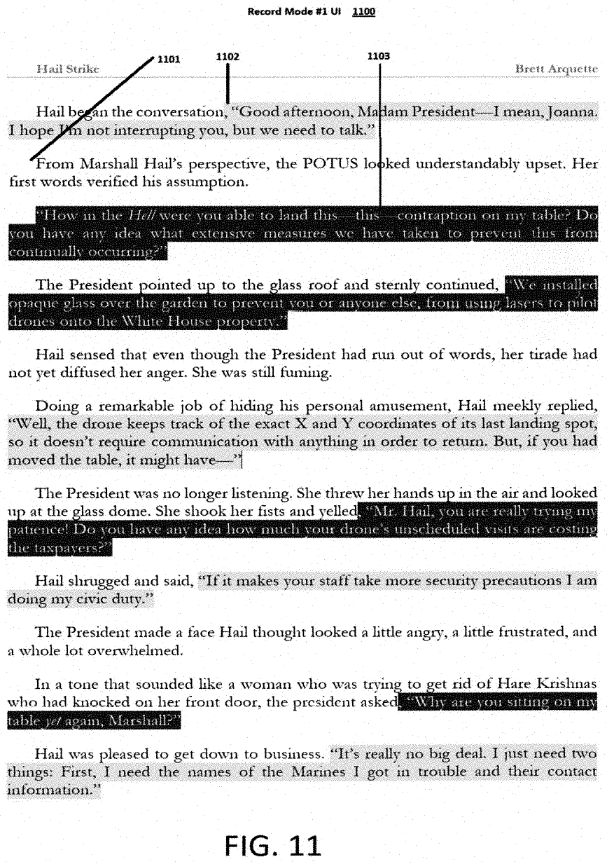

FIG. 11 Record Module #1 UI—is an illustration of one of the two recording modes offered to human narrators who record snippets 1100. Record Mode #1 formats the snippets in a manner to mirror the original text file (book). Since this view is formatted in a traditional manner, that in which traditional narrators are accustomed, this format/mode might be popular with experienced narrators. The character colors are incorporated in this mode. For example: the narrator is not assigned a color, so the narrator color is black and white, which still individualizes the snippet from others in the same paragraph 1001. In this example, the black over gold designates one character 1002, while white over blue designates another character 1003.

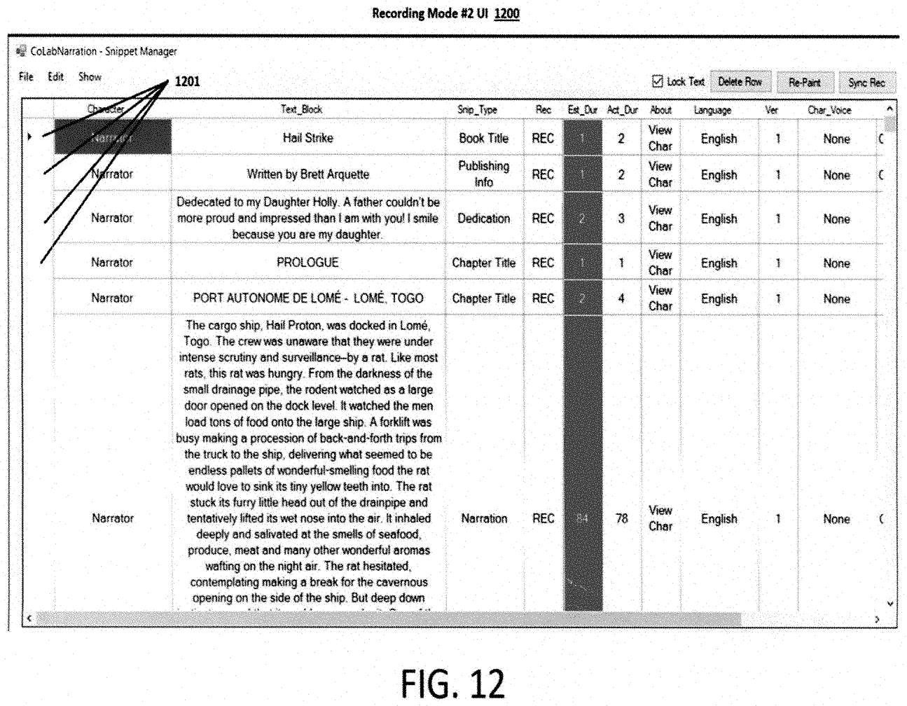

FIG. 12 Recording Mode #2 UI—is a screen shot of the Snippet Manager 1200. This screen would constitute the second mode of recording audio. In this mode, the author is presented a serialized version of the text, broken down into individual snippets. In this mode, the narrator has the option of recording all audio snippets for just one character, or record line after line by moving down the data grid. In this illustration 1201 each snippet is recorded in a line by line method.

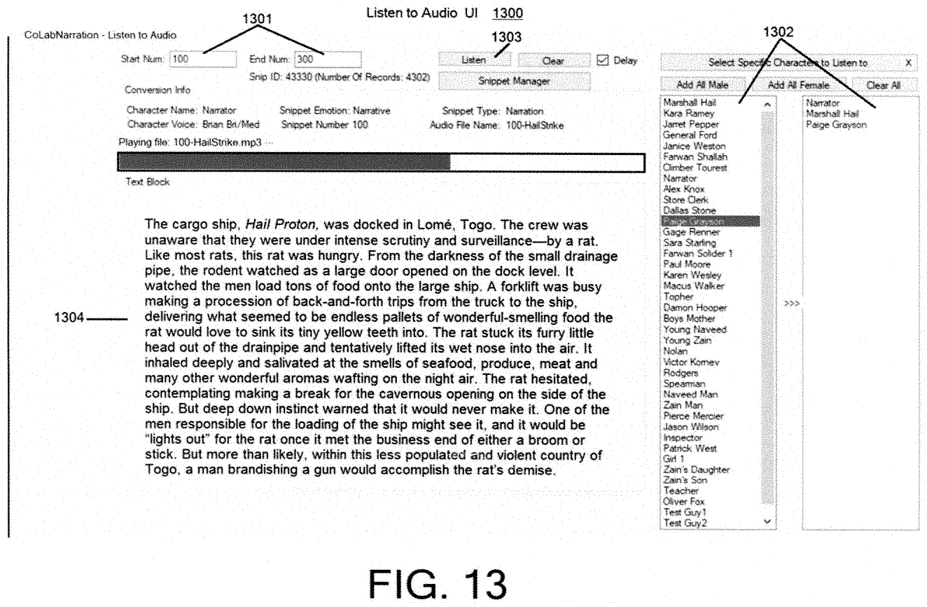

FIG. 13 Listen to Audio UI—is a screen shot of the process that allows authors and narrators to review audio that has been recorded or virtualized 1300. This process mimics the concatenation process, with the exclusion of silence being added to separate the snippets. This process could be considered a method of listening to the raw audio, audio which has not been optimized or normalized. This UI allows the user to listen to all audio between the Start snippet number and the End snippet number 1301. The user can also listen to audio by selecting the character they want to hear 1302. If a list of characters has been selected, then each character is read when it is encountered in snippet file. This method may be needed for a narrator to listen to a back and forth conversation between characters, thus gauging their own performance. To start the process, the user selects a combination of character and snippet number and clicks on the Listen button 1303.

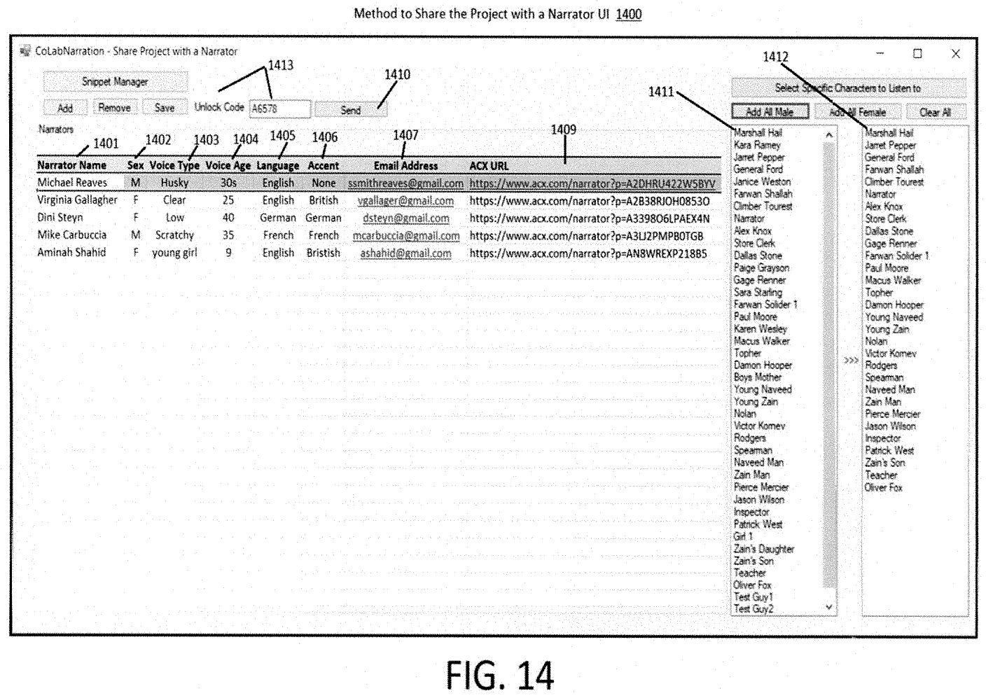

FIG. 14 Method to Share the Project with a Narrator UI—is a screen shot of the process that allows to an author to share the project with multiple narrators 1400. The list of narrators used in the project are contained in the narrator file. Fields in the narrator file are Narrator Name showing the name of the narrator for hire 1401; the sex of the narrator, male or female 1402; the voice type of the narrator, which describes the tone of the narrators voice 1403; the Voice Age that shows the actual age of the narrator or the age in which their voice sounds 1404. The Language field indicates the language or languages the narrator can speak 1405. The Accent field shows what type of Accent the narrator has (for example, the author may want need a narrator who can speak in an Texan accent). If this were the case then the text in this field would be “Texan” 1406. The Email Address field is the email address of the narrator and is used to email the project to the narrator 1407. The ACX URL is a link that each narrator has if they are a member of the Audible ACX list of narrators 1409. This link allows the author to jump directly to this narrator's page on the ACX platform and listen to audio samples the narrator has submitted. All the characters in the project are shown in the left list box 1411 and each time the author clicks on a name, that name is added to right list box 1412. The left box represents the characters that have been assigned to the narrator “Michael Reaves”. The author is required to enter a mixed character code in the Unlock Code text box 1413. This code is included within the email the narrator receives when a project is emailed to him/her. Upon the import of the project into the narrators CoLabNarration software, they are prompted to enter this code. In the background, all characters are locked to recording except those that have been assigned to the narrator, protected by the Unlock Code. After the author has selected characters for a specific narrator, by clicking the Send button 1410, an email is sent to the narrator containing links, codes, and general information they will require.

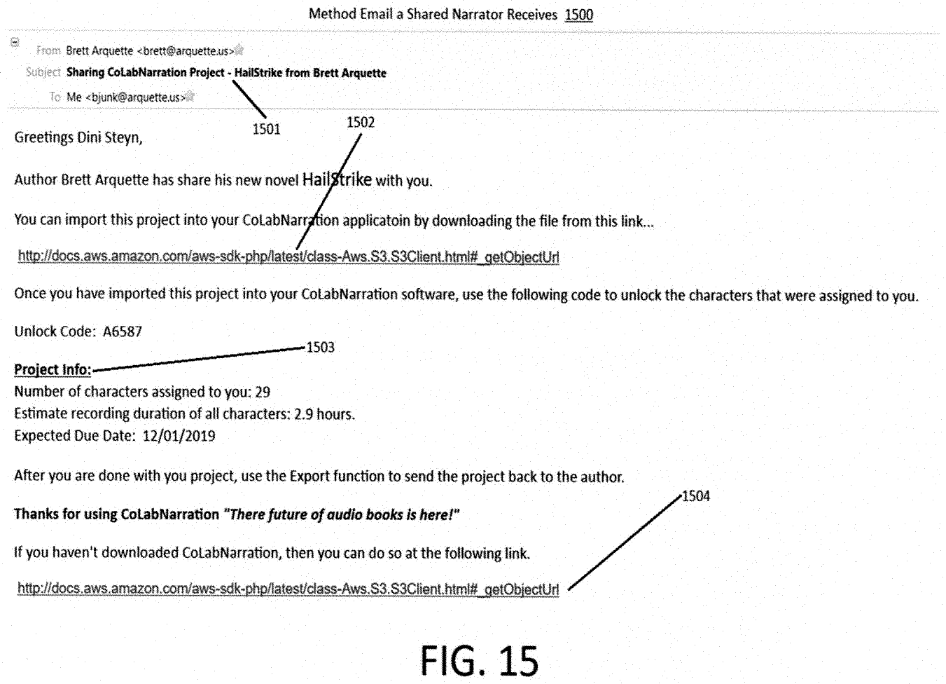

FIG. 15 Method Email a Shared Narrator Receives—is an example email that illustrates the method an author shares their project with a narrator 1500. Within this email, the project name and author are represented in the Subject line 1501. During the sharing process, the zipped project file is uploaded to an Amazon S3 bucket and associated with a download link to file 1502. Additionally, a brief block of Project information is sent that provides the narrator with the basic information required 1503. Finally, a link to the full production version of the CoLabNarration software is present, so if they are a narrator new to this process, they can download the software.

The Colabnarration application was developed with conventional tools used in unconventional ways to create a new product that non-technical people, authors, can use to develop an audio book. In Colabnarration the inventor has also created unconventional tools, which previously did not exist, in order to solve the business problems related to creating an audio book. Taken together, Colabnarration is a unique product, with a narrow scope, that solves a number of specific problems for an author creating an audio book.

The invention claimed is:

1. A method for generating an audio book from a text file, comprising: receiving a text file of an author's book as input to a serialized process that creates a record of each paragraph of text; creating a character file with associated character attributes and information required for the recording process and or virtualization process; combining the serialized file with the character file to create a snippet file; assigning characters to snippets; generating audio files from snippets using text-to-speech APIs; sharing snippets with narrators to record specific characters not represented by text-to-speech synthesized audio; and concatenating all audio files from snippets, with proper time spacing, into a publishable audio book format.

2. The method of claim 1 wherein a character file is created, the characters and their attributes, such as age, race, sex, personality, physical build, voice qualities, human narrator or synthesized audio, are identified.

3. The method of claim 1 where snippets of text are assigned to a character, can be edited, and audio played back.

4. The method of claim 1 where snippets are concatenated, and audio files created through links to text-to-speech API processes.

5. The method of claim 1 where snippets are concatenated and shared with a human narrator and received back into the CoLabNarration process as audio files.

6. The method of claim 1 where audio files from all text-to-speech and/or human narration are concatenated, time spaced corrected for playback, and a set of one or more-hour long audio book formatted files are created.
